(19) United States
(12) Patent Application Publication
(10) Pub. No.: US 2014/0214675 A1
(43) Pub. Date: Jul. 31, 2014

(54) PUSH PAYMENT SYSTEM AND METHOD

(71) Applicants: Pankaj Sharma, Singapore (SG); Vikram Modi, Singapore (SG); Shantnu Singh, Singapore (SG); Geir Forde, Manly (AU); Karen Cervenka, Belmont, CA (US)

(72) Inventors: Pankaj Sharma, Singapore (SG); Vikram Modi, Singapore (SG); Shantnu Singh, Singapore (SG); Geir Forde, Manly (AU); Karen Cervenka, Belmont, CA (US)

(21) Appl. No.: 14/162,647

(22) Filed: Jan. 23, 2014

Related U.S. Application Data
(60) Provisional application No. 61/757,064, filed on Jan. 25, 2013.

(51) Int. Cl. G06Q 20/40; G06Q 20/10

(52) U.S. Cl. CPC G06Q 20/40; G06Q 20/10
USPC 705/44

(57) ABSTRACT

Embodiments of the invention introduce systems and methods for using a payment processing network to conduct transactions between accounts not associated with the payment processing network. One embodiment of the invention discloses a method for conducting a funds transfer transaction. The method comprises receiving a recipient bank identifier and a recipient account identifier associated with a recipient account, determining a recipient bank primary account number (PAN) using the recipient bank identifier, generating an authorization request message comprising the recipient bank PAN and the recipient account identifier, sending an authorization request message for a transaction to a recipient bank computer, wherein the recipient bank PAN is used to route the authorization request message to the recipient bank computer, and receiving an authorization response message.

### CROSS-REFERENCES TO RELATED APPLICATIONS

The present application is a non-provisional application of and claims priority to U.S. Provisional Application No. 61/757,064, filed on Jan. 25, 2013 (Attorney Docket No.: 79900-861401), the entire contents of which are herein incorporated by reference for all purposes.

### BACKGROUND

Payment processing networks such as VisaNet™ for Visa® accounts and Banknet™ for MasterCard® accounts allow users to conduct transactions in substantially real-time. However, in some cases, a user may desire to conduct a transaction with a second user whose account may not be associated with a payment processing network that the user wants to use. In such cases, the second user may not have an account identifier, or the account identifier may not be usable by the desired payment processing network to conduct the transaction.

Embodiments of the invention address these and other problems.

### SUMMARY

Embodiments of the invention introduce systems and methods for using a payment processing network to conduct transactions between accounts not associated with the payment processing network.

One embodiment of the invention discloses a method for conducting a funds transfer transaction. The method comprises receiving a recipient bank identifier and a recipient account identifier associated with a recipient account, determining a recipient bank primary account number (PAN) using the recipient bank identifier, generating an authorization request message comprising the recipient bank PAN and the recipient account identifier, sending an authorization request message for a transaction to a recipient bank computer, wherein the recipient bank PAN is used to route the authorization request message to the recipient bank computer, and receiving an authorization response message.

One embodiment of the invention discloses a server computer. The server computer comprises a processor and a non-transitory computer-readable storage medium, comprising code executable by the processor for implementing a method comprising receiving a recipient bank identifier and a recipient account identifier associated with a recipient account, determining a recipient bank primary account number (PAN) using the recipient bank identifier, generating an authorization request message comprising the recipient bank PAN and the recipient account identifier, sending an authorization request message for a transaction to a recipient bank computer, wherein the recipient bank PAN is used to route the authorization request message to the recipient bank computer, and receiving an authorization response message.

One embodiment of the invention discloses a computer-implemented method. The method comprises receiving an authorization request message for a transaction, the authorization request message comprising a recipient account identifier, determining that the authorization request message includes a bank primary account number (PAN), determining a recipient account using the recipient account identifier, and sending an authorization response message to a sending bank computer.

One embodiment of the invention discloses a server computer. The server computer comprises a processor and a non-transitory computer-readable storage medium, comprising code executable by the processor for implementing a method comprising receiving an authorization request message for a transaction, the authorization request message comprising a recipient account identifier, determining that the authorization request message includes a bank primary account number (PAN), determining a recipient account using the recipient account identifier, and sending an authorization response message to a sending bank computer.

Further details regarding embodiments of the invention can be found in the Detailed Description and the Figures.

### BRIEF DESCRIPTION OF THE DRAWINGS

FIG. 1 shows a system for conducting transactions according to embodiments of the invention.

FIG. 2 shows a system for conducting transactions using a bank primary account number (PAN) database according to embodiments of the invention.

FIG. 3 shows an example of a sending bank computer.

FIG. 4 shows the structure of an exemplary bank PAN database.

FIG. 5 illustrates an example of a bank PAN according to some embodiments of the invention.

FIG. 6 shows a method of transferring funds from a sending party to a recipient party.

FIG. 7 shows a flow diagram illustrating an example of a funds transfer according to one embodiment of the invention.

FIG. 8 shows an example of an original credit transaction (OCT) authorization request message in one embodiment of the invention.

FIG. 9 shows an example of an OCT authorization response message according to one embodiment of the invention.

FIG. 10 shows an exemplary payment device in the form of a card.

FIG. 11 is a high level block diagram of a computer system that may be used to implement any of the entities or components described for embodiments of the invention.

### DETAILED DESCRIPTION

Prior to discussing embodiments of the invention, description of some terms may be helpful in understanding embodiments of the invention.

The term “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

A “primary account number” (PAN) may include any string, sequence of digits, or other identifier suitable to identify an account associated with a payment processing network. In some cases, PAN may include an issuer identification number, an individual account identifier, and a check digit. For example, a PAN may comprise the 16-digit sequence: “4123-4567-8901-2345” (the sequence has been broken into groups of 4 digits for readability). However, a PAN may be structured in any other suitable manner.

An “issuer identification number” (IIN) may include any string, sequence of digits, or other identifier suitable to identify an issuer, bank, institution, or other entity maintaining an account associated with a payment processing network. Typically, an IIN may be the first digits of a PAN. For example, for the PAN “4123-4567-8901-2345,” the IIN may be the 6 digits: “412345.” However, an IIN may be of any suitable length. In some cases, an IIN may be registered with a payment processing network as associated with a network address for an entity maintaining an account. Accordingly, the payment processing network may examine the IIN of a PAN to route a transaction conducted using the PAN.

An “individual account identifier” (IAI) may include any string, sequence of digits, or other identifier suitable to identify a user's account. Typically, an IAI may be the digits following an IIN in a PAN. For example, for the PAN “4123-4567-8901-2345,” the IAI may be the 9 digits: “678901234.” However, an IAI may be of any suitable length. Typically, an IAI uniquely identifies a user's account at an entity maintaining the account. However, an IAI may also be a phone number, nickname, or other identifier of an account. Two PANs corresponding to different accounts may have the same IAI if they have different IINs (e.g., if different issuers maintain the accounts). In some cases, a payment processing network, issuer, or other entity may link an IAI to another IAI that may be used by other entities for routing, processing, or other functionality.

A “check digit” may include any string, sequence of digits, or other value used to detect or correct errors in a PAN. A check digit may be computed using any suitable error detection or correction code, such as a simple checksum, Luhn's algorithm, a Hamming code, or a hash function. Typically, a check digit may be represented using a single numeric digit. However, a check digit may be of any suitable length and format.

A “bank primary account number,” or “bank PAN” may include a PAN associated with an issuer, bank, institution, or other entity maintaining an account. Thus, whereas a PAN may generally be associated with a user's account, a bank PAN may be associated with a bank itself. In addition, transactions from multiple accounts maintained by the same bank may use the same bank PAN. A bank PAN typically comprises the same elements as other PANs, such as an IIN, a IAI, and a check digit. In some cases, each bank PAN is may be associated with a different bank or other entity. In such cases, no two bank PANs would have the same IIN.

A “bank identifier” may include any string, number, or other identifier suitable to identify a bank, issuer, institution, or other entity that maintains an account. Examples of bank identifiers may include a routing transit number (RTN; e.g., for US banks), Bank State Branch (BSB) code (e.g., for Australian banks), or Bank Identification Code (BIC; e.g., for international banks). In some cases, the bank identifier may not be associated with a payment processing network. A “recipient bank identifier” may include a bank identifier for a recipient party.

A “sending account” may include any account associated with a party sending funds in a transaction. For example, a sending account may be an account associated with a payment processing network, such as a credit card account or debit card account. In other cases, a sending account may be a bank account or other account not associated with a payment processing network. In yet other cases, the sending account may refer to a non-account instrument, such as a cash payment.

A “recipient account” may include any account associated with a recipient of funds in a transaction. In some cases, the recipient account may be an account associated with a payment processing network, such as a credit card account, debit card account, or an account associated with a payment token. In other cases, the recipient account may be a bank account or other account not associated with a payment processing network (e.g., a prepaid account, a deposit account with a biller or merchant, a transit transponder account, a mobile account, etc.). For example, in some cases, the recipient account may not be associated with a PAN. The recipient account may be maintained by a “recipient bank.”

A “recipient account identifier” may include any string, number, or other identifier suitable to identify a recipient account. For example, a recipient account identifier may be a checking account number (e.g., if the account is a checking account), a savings account number (e.g., if the account is a savings account), or a token representing an account.

Embodiments of the invention relate to a system and method for the real-time transfer of funds from a sending account to a recipient account. During a funds transfer transaction, a sending party computer may send to a sending bank computer a recipient account identifier associated with the recipient account, and a recipient bank identifier associated with a recipient bank. The sending bank computer may use the recipient bank identifier to retrieve a bank primary account number (PAN) associated with the payment processing network for the recipient bank. The sending bank computer may then include information regarding the recipient account identifier and recipient bank identifier in an authorization request message sent via the payment processing network using the bank PAN to a recipient bank computer. The recipient bank computer may receive the authorization request message and determine that the authorization request includes a bank PAN. If the transaction is approved, the recipient bank computer may then credit the recipient account corresponding to the recipient account identifier received in the authorization request. The recipient bank computer may then send an authorization response message indicating whether the transaction was approved.

Embodiments of the invention provide for many technical advantages. For instance, embodiments enable a payment processing network to conduct transactions between accounts that may not be associated with or relate to that particular payment processing network. In many cases, a user may desire to transfer funds to an account not associated with a payment processing network that the user wants to use. For example, a user may desire to transfer funds to a checking account at a bank using a real-time payment processing network. In this manner, a funds transfer to a checking account can be completed in substantially real-time instead of one or more days that such a transfer may otherwise take to complete. Using a real-time payment processing network also allows a timed transaction (e.g., a standing order or a pre-designated transaction) to be performed in real-time once a condition is met. In order to achieve these advantages, embodiments of the invention may send an authorization request message using a bank PAN, a transaction authorization request message may be appropriately routed over a payment processing network to a recipient bank even if a PAN corresponding to the recipient account does not exist in the payment processing network being used. Once received, the recipient bank may parse the message to determine a recipient account to credit. Since an authorization request is typically transmitted as soon as a transaction occurs, the transfer may happen in substantially real-time.

In contrast, bank drafts (e.g., Automated Clearing House (ACH) for US transactions, and Australian Payments Clearing Association (APCA) for Australian tranasctions) may take days to clear and have funds available due to the batch nature of such transfers. Wire transfers (e.g., Society for Worldwide Interbank Financial Telecommunication (SWIFT) transactions) may allow real-time funds transfer, but are expensive both computationally and in terms of network resources required. This expense is often reflected in an increased cost to users. Thus, embodiments of the invention allow the combined efficiency and speed of payment processing networks to be used for a greater number of transactions.

In addition, embodiments of the invention allow for a greater number of accounts to make use of a payment processing network. In some cases, PANs in a payment processing network may be restricted to a number of digits (e.g., 16 digits). A number of those digits may be reserved for an IIN, and a number may be reserved as check digits. Thus, the number of possible accounts that may be represented using PANs is limited. Embodiments of the invention allow for a greater number of accounts to be serviced by a payment processing network by including a recipient account identifier and a recipient bank identifier as a part of an authorization request message separate from a PAN field. By using a bank PAN shared by many accounts, embodiments allow messages to be routed appropriately in a payment processing network. The the recipient account identifier and the recipient bank identifier may be used by the endpoints of the network (e.g., a sending bank computer and recipient bank computer) to conduct the transaction. Thus, embodiments of the invention allow a greater number and variety of accounts to conduct transactions using a payment processing network without requiring changes to existing infrastructure.

The above examples highlight only a few of the advantages of using a bank PAN to allow a payment processing network to conduct transactions between accounts that may not be associated with or relate to the payment processing network being used.

I. Exemplary Systems

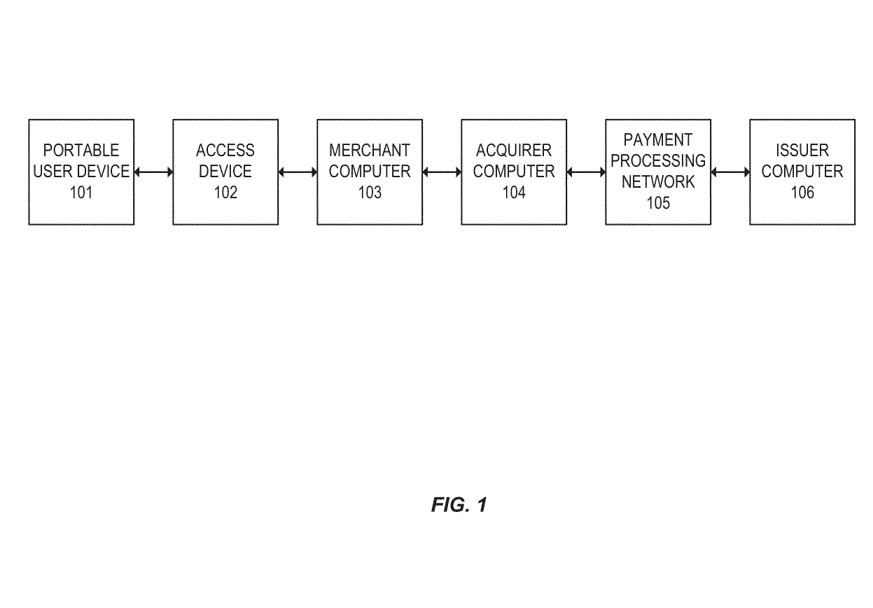

FIG. 1 shows a system according to an embodiment of the invention. The system comprises a user (not shown) who may operate a portable consumer device 101. The consumer may use portable device 101 to conduct purchase transactions at an access device 102 connected to a merchant computer 103. Merchant computer 103 may be connected to acquirer computer 104. Acquirer computer 104 may be connected to issuer computer 106 via payment processing network 105.

As used herein, an “issuer” may typically refer to a business entity (e.g., a bank) that maintains financial accounts for a consumer and often issues a portable consumer device 101 such as a credit or debit card to the consumer. A “merchant” is typically an entity that engages in transactions and can sell goods or services. An “acquirer” is typically a business entity (e.g., a commercial bank) that has a business relationship with a particular merchant or other entity. Some entities can perform both issuer and acquirer functions. Some embodiments may encompass such single entity issuer-acquirers. Each of the entities (e.g., merchant computer 103, acquirer computer 104, payment processing network 105, and issuer computer 106) may comprise one or more computer apparatuses to enable communications or to perform one or more of the functions described herein.

The payment processing network 105 may include data processing subsystems, networks, and operations used to support and deliver certificate authority services, authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. In some embodiments, payment processing network 105 may conduct transactions in substantially real-time.

The payment processing network 105 may include one or more server computers. A server computer is typically a powerful computer or cluster of computers. For example, the server computer can be a large mainframe, a minicomputer cluster, or a group of servers functioning as a unit. In one example, the server computer may be a database server coupled to a Web server. The payment processing network 105 may use any suitable wired or wireless network, including the Internet.

In a typical purchase transaction, the user purchases a good or service at merchant 103 using a portable consumer device 101 (e.g., a payment card, a mobile phone, etc.). The user's portable consumer device 101 can interact with an access device 102 at a merchant associated with merchant computer 103. For example, the consumer may tap the portable consumer device 101 against an NFC reader in the access device 102. Alternately, the consumer may indicate payment details to the merchant electronically, such as in an online transaction.

An authorization request message is generated by the access device 102 and is then forwarded to the acquirer computer 104. Typically, the authorization request message will include a field for a primary account number (PAN) associated with the portable consumer device 101. After receiving the authorization request message, the authorization request message is then sent to the payment processing network 105. The payment processing network 105 then forwards the authorization request message to the corresponding issuer computer 106 associated with the issuer of the portable consumer device 101. The PAN included in the authorization request message may be used to route the message to the appropriate issuer computer 106.

An “authorization request message” may be an electronic message that is sent to a payment processing network and/or an issuer of a payment card to request authorization for a transaction. An authorization request message according to some embodiments may comply with ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CW (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction. The authorization request message may also include other information such as information that identifies the access device that generated the authorization request message, information about the location of the access device, etc.

After the issuer computer 105 receives the authorization request message, the issuer computer 105 sends an authorization response message back to the payment processing network 200 to indicate whether or not the current transaction is authorized (or not authorized). The payment processing network 200 then forwards the authorization response message back to the acquirer 104. The acquirer 104 then sends the response message back to the merchant computer 103. In some embodiments, such as when a fraud rule is triggered at payment processing network 200, payment processing network 200 may decline a transaction previously authorized by issuer computer 105.

An “authorization response message” may be an electronic message reply to an authorization request message generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g. POS equipment) that indicates approval of the transaction. The code may serve as proof of authorization. As noted above, in some embodiments, a payment processing network may generate or forward the authorization response message to the merchant.

After the merchant computer 103 receives the authorization response message, the access device at the merchant computer 103 may then provide the authorization response message for the consumer. The response message may be displayed by the contactless access device, or may be printed out on a receipt. Alternately, if the transaction is an online transaction, the merchant may provide a web page or other indication of the authorization response message.

At the end of the day, a normal clearing and settlement process can be conducted by the payment processing network 105. A clearing process is a process of exchanging financial details between and acquirer and an issuer to facilitate posting to a user's payment account and reconciliation of the user's settlement position. However, it should be noted that embodiments of the invention are not limited to a single settlement process.

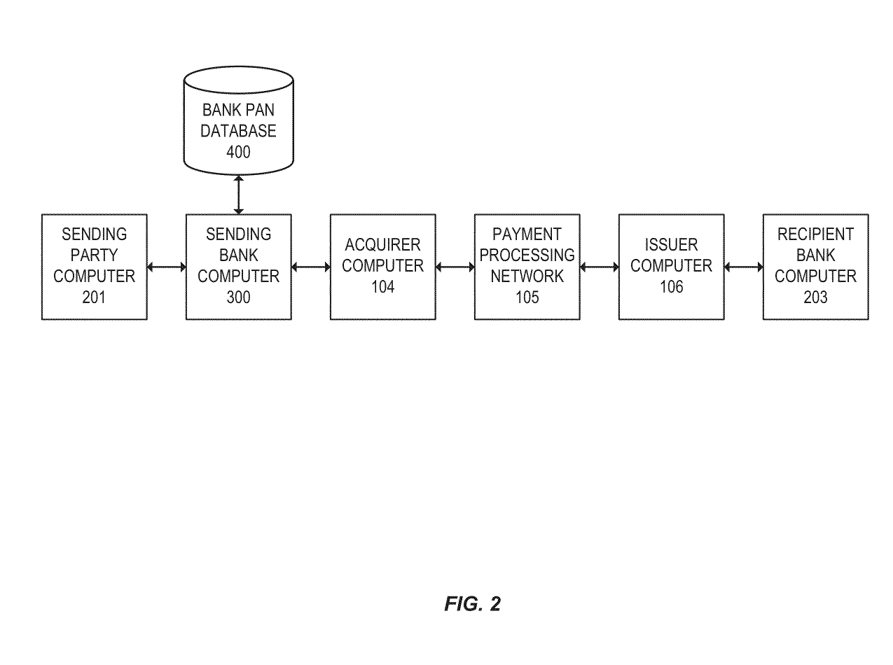

FIG. 2 shows a system for conducting transactions using a bank primary account number (PAN) database according to embodiments of the invention. The system of FIG. 2 includes acquirer computer 104, payment processing network 105, and issuer computer 106 of FIG. 1. In addition, the system comprises a sending party computer 201, a sending bank computer 300, a bank PAN database 400 connected to sending bank computer 300, and a recipient bank computer 203.

Sending party computer 201 may be a computing device configured to initiate a transfer from a sending account. Sending party computer 201 may be operated by a user. For example, sending party computer 201 may be a mobile device, a personal computer, or a server computer.

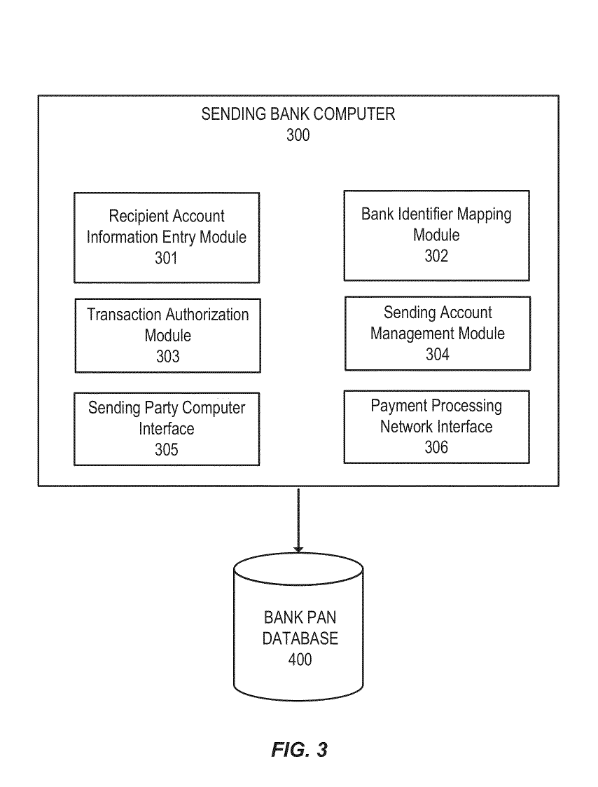

Sending bank computer 300 may be any server computer configured to receive information regarding a transfer to a recipient account, determine a bank PAN associated with the recipient account, and/or generate an authorization request message for the transfer. In some embodiments, sending bank computer 300 may present an interface to sending party computer 201. For example, sending bank computer 300 may provide a web site or application programming interface (API) operable by sending party computer 201. In some cases, sending bank computer 300 may operate as an acquirer computer 104. A more detailed illustration of sending bank computer 300 in some embodiments of the invention is shown in FIG. 3.

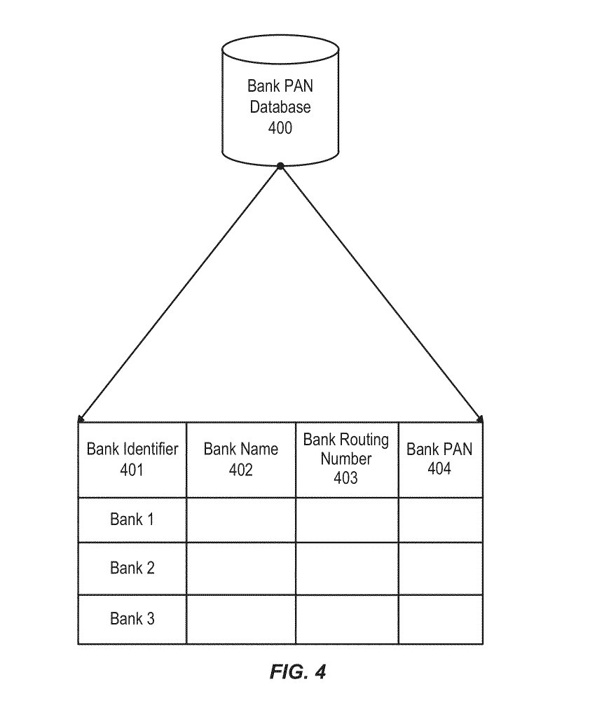

Bank PAN database 400 may be a database, repository, or other system configured to store an association between a bank identifier and a bank PAN. For example, in some embodiments, the bank identifier may be the name of a bank. In some embodiments, the bank identifier may be a bank routing number. A more detailed illustration of bank PAN database 400 is shown in FIG. 4.

Recipient bank computer 203 may be any server computer configured to receive an authorization request message including a bank PAN and determine a recipient account using the authorization request message. Typically, recipient bank computer 203 maintains a recipient account for a recipient party.

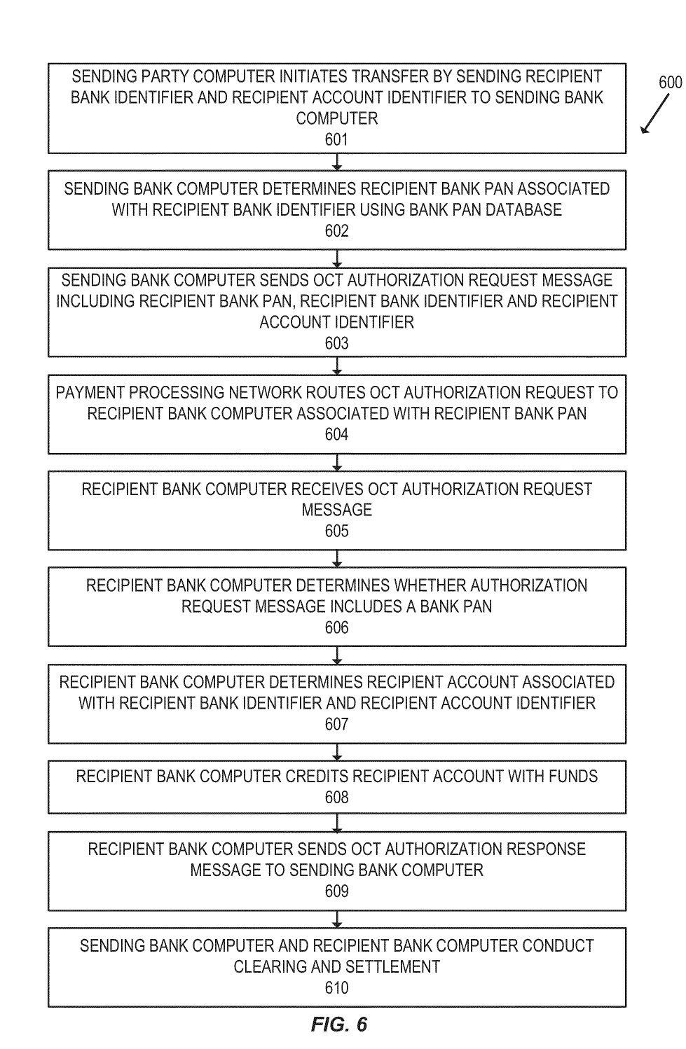

In a typical process, a sending party may use sending party computer 201 to specify a recipient account identifier and a recipient bank identifier for a recipient. The recipient bank identifier may be used by sending bank computer 300 to determine a bank PAN from bank PAN database 400 that is associated with the recipient bank computer 203. Subsequently, sending bank computer 300 and recipient bank computer 203 may conduct a transaction. One example of a method for conducting a transaction using the system of FIG. 2 is shown in FIG. 6.

FIG. 3 shows an example of a sending bank computer according to some embodiments of the invention. As shown, the sending bank computer may comprise one or more modules, such as recipient account information entry module 301, bank identifier mapping module 302, transaction authorization module 303, sending account management module 304, sending party computer interface 305, and payment processing network interface 306. The described modules and interfaces may be implemented using any suitable combination of computer software and hardware, and may be combined into fewer or separated into more modules and interfaces than shown.

Recipient account information entry module 301 may be configured to accept recipient account identifiers and recipient bank identifiers for transactions. For example, in some cases, a sending party (e.g., a user) may initiate a transaction at the user's sending bank. For example, the user may enter the recipient's account identifier and bank identifier using a keypad. Recipient account information entry module 301 may be configured to receive and parse the data entered by the user.

Bank identifier mapping module 302 may be configured to communicate with bank PAN database 400 to determine a bank PAN associated with a bank identifier.

Transaction authorization module 303 may be configured to generate, format, and receive authorization request messages and authorization response messages. In some embodiments, transaction authorization module may implement a messaging standard, such as ISO 8583. In some embodiments, the transaction authorization module may extend a standard to support additional data fields for a recipient account identifier and a recipient bank identifier.

Sending account management module 304 may be configured to manage and maintain the sending account. Sending account management module 304 may include general banking functionality, such as handling deposits to and withdrawals from the account. In addition, sending account management module 304 may be operable to calculate interest and fees, and any other functionality required to maintain the sending account.

Sending party computer interface 305 may be configured to communicate with sending party computer 201. For example, in some embodiments, sending party computer interface 305 may be an application programming interface (API), web site, or other functionality operable to receive recipient account identifiers and recipient bank identifiers from sending party computer 201.

Payment processing network interface 305 may be configured to communicate with acquirer computer 104, payment processing network 105, and issuer computer 106. For example, payment processing network interface 305 may include an internet address of an acquirer computer 104 associated with sending bank computer 300.

FIG. 4 shows the structure of an exemplary bank PAN database 400. Bank PAN database 400 may comprise a plurality of fields associated with a bank, such as a bank identifier field 401, a bank name field 402, a bank routing number field 403, and a bank PAN field 404.

Bank identifier field 401 may include any suitable bank identifier for the bank. In some embodiments, bank PAN database 400 may assign a serial or otherwise unique number to each recipient bank with a recipient bank PAN.

Bank name field 402 may include any suitable name, nickname, or alias of the bank. For example, bank names for Bank of America™ may include “Bank of America Corporation,” “Bank of America,” and “BofA.”

Bank routing number field 403 may include any suitable number, string, or other identifier for a bank routing number associated with the bank. Examples of a routing number may include a routing transit number (RTN), a Bank State Bank (BSB) code, or any other suitable bank code.

Bank primary account number (PAN) field 404 may include a bank PAN associated with the bank.

Bank PAN database 400 may be used to retrieve the value of a bank PAN field 404 using any of fields 401-403. For example, in some cases, a bank name may be used to retrieve a bank PAN. In some cases, a bank routing number may be used to retrieve a bank PAN. In some cases, another suitable bank identifier may be used to retrieve a bank PAN.

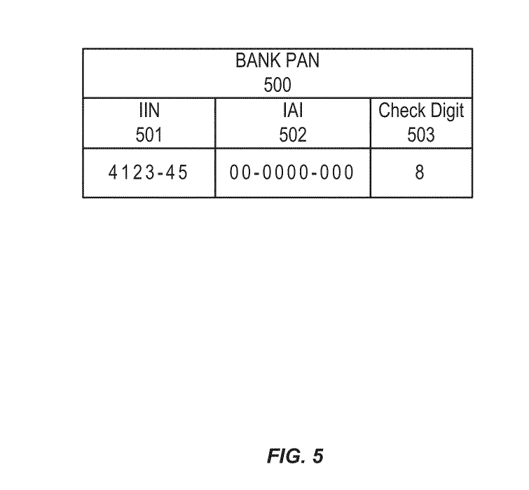

FIG. 5 shows an example of a bank PAN 500 in some embodiments of the invention. As shown in FIG. 5, bank PAN 500 comprises an issuer identification number (IIN) 501, an individual account identifier (IAI) 502, and a check digit 503. In the shown example, the IIN is the 6-digit number: “412345.” The IAI is the 9-digit number: “000000000.” The check digit is a single digit “8.”

In some embodiments, only the IIN may be used to route transactions through a payment processing network 105. In such embodiments, the IAI for bank PANs may be a constant value (e.g., all zeroes). This may be because the IIN included in the bank PAN corresponds to a recipient bank that does not issue PANs for individual accounts. Accordingly, in some cases, there may be only one valid PAN that uses a certain IIN.

II. Exemplary Bank PAN Transaction Methods

FIG. 6 shows a method 600 of transferring funds from a sending party to a recipient party.

At step 601, sending party computer 201 initiates a transfer by sending a recipient bank identifier and a recipient account identifier to a sending bank computer 300. The sending party computer 201 may determine the recipient bank identifier and recipient account identifier in any suitable manner. For example, in some embodiments, the sending party may indicate to sending party computer 201 the desire to conduct a transfer. Sending party computer 201 may then prompt the sending party to enter bank and account information from the recipient in a web form or application.

At step 602, sending bank computer 300 determines a recipient bank PAN associated with the received recipient bank identifier using bank PAN database 400. For example, if the recipient bank identifier for “Bank A” was an American Banking Association (ABA) routing transit number (e.g., “142394940”) a corresponding recipient bank PAN (e.g., “4123-8947-5345-2342”) may be retrieved from bank PAN database 400. In some embodiments, the bank PAN may be determined solely from the recipient bank identifier.

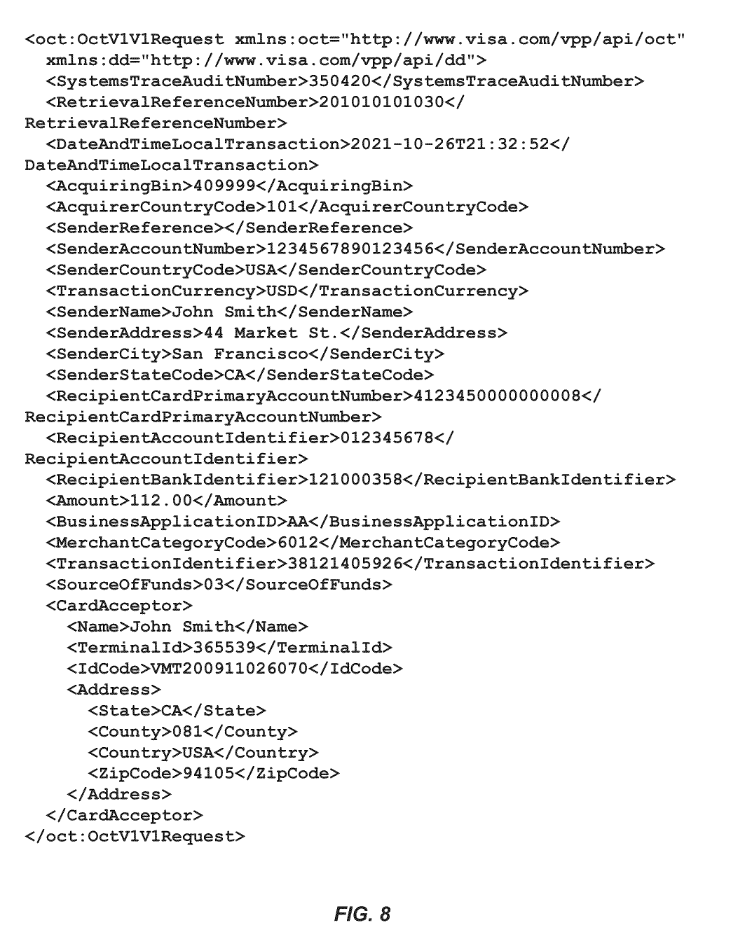

At step 603, sending bank computer 300 sends an original credit transaction (OCT) authorization request message including the recipient bank PAN determined in step 602 and the recipient account identifier. An “original credit transaction” (OCT) authorization request message may be similar to an authorization request message, but may include additional fields relating to a funds transfer transaction. For example, an OCT authorization request message may include a field relating to how the transaction was funded (e.g., with a credit card, cash, check, etc.). The OCT authorization request message may be sent to an acquirer computer 104 or directly to payment processing network 105. An example of an OCT authorization request message is shown in FIG. 8. In some embodiments, the OCT authorization request message may also include a recipient bank identifier.

At step 604, payment processing network 105 routes the OCT authorization request message to a recipient bank computer 203 associated with the recipient bank PAN. In some embodiments, a directory, hash table, or other data structure may be used to map a bank PAN to a network address of the recipient bank PAN computer 203. In some embodiments, only the IIN of the bank PAN may be used to route the transaction. For example, if the bank PAN is “4123-4567-8901-2345,” and the IIN is the first six digits, the payment processing network may use the sequence “412345” to determine routing for the authorization request message.

In some cases, such as when the recipient bank computer 203 is not a part of the payment processing network, the authorization request message may instead be routed to an issuer computer 106. The issuer computer 106 may then forward the authorization request message to the recipient bank computer 203.

At step 605, recipient bank computer 203 receives the OCT authorization request message.

At step 606, recipient bank computer 203 determines whether the authorization request message includes a bank PAN. For example, in some cases, a PAN may be determined to be a bank PAN if the IAI is all zeroes or another fixed value.

In some cases, the OCT authorization request message may include a PAN associated with a recipient account. In such cases, the recipient bank computer 203 may process the authorization request in as described for the system of FIG. 1. For example, the PAN may be used to lookup an individual account. However, if the authorization request message includes a bank PAN, the PAN alone may not be sufficient to determine a recipient account.

At step 607, recipient bank computer 203 parses the authorization request message to determine the recipient account identifier and, if included, a recipient bank identifier. Recipient bank computer 203 then determines an recipient account associated with the recipient account identifier and the recipient bank identifier. In some embodiments, the recipient bank identifier may not be needed to determine the recipient account.

At step 608, if a recipient account is determined and is approved to receive the transfer, recipient bank computer 203 credits the recipient account with funds from the transfer. In some embodiments, the credit may be substantially real-time, so that the funds may be available for withdrawal in the recipient account once the authorization request message has been received and processed.

At step 609, recipient bank computer 203 sends an original credit transaction authorization response message to sending bank computer 203. The “original credit transaction” (OCT) authorization response message may indicate whether the transaction was successful. The OCT authorization response message may be routed using the payment processing network 105.

At step 610, sending bank computer 300 and recipient bank computer 203 conduct a clearing and settlement operation to finalize the transfer. In some embodiments, the clearing and settlement may occur in a batch process, so that multiple transfers conducted between the sending bank computer 300 and recipient bank computer may be settled simultaneously.

It should be noted that although method 600 describes one method for conducting a transfer, embodiments of the invention are not so limited. For example, the authorization request and response messages do not need to be in the OCT format. Rather, in various embodiments, the request and response messages may be formatted in any suitable manner.

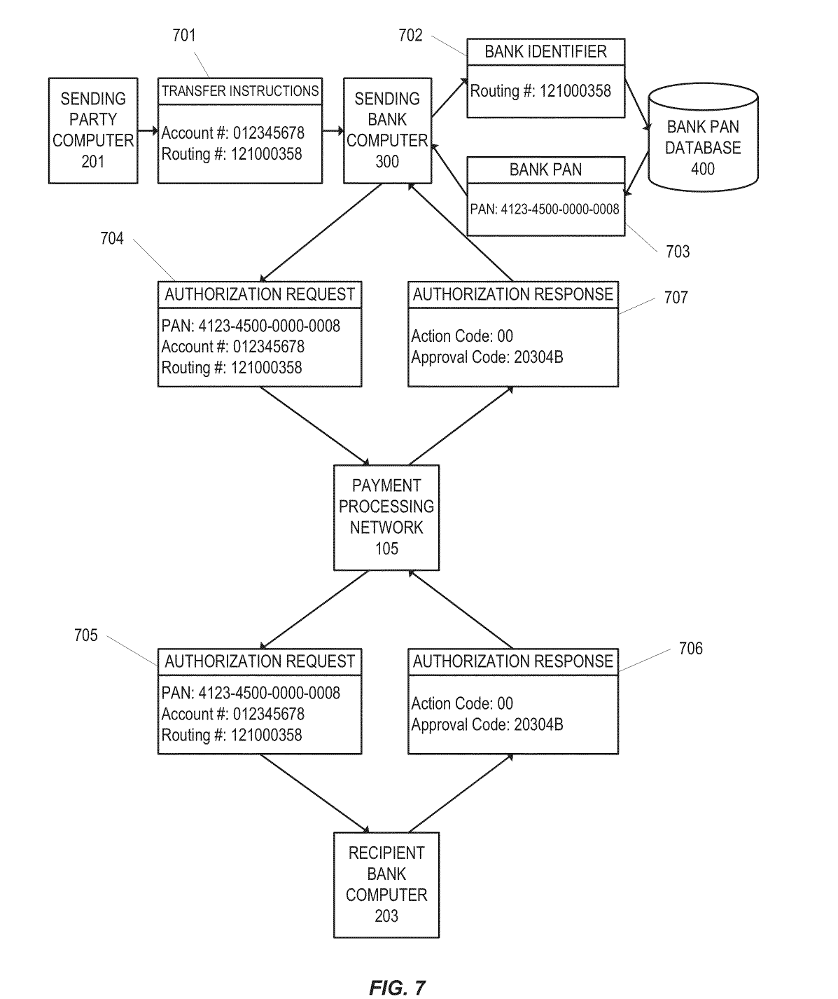

FIG. 7 shows a flow diagram illustrating an example of a funds transfer transaction according to one embodiment of the invention. As shown in FIG. 7, the funds transfer transaction may be conducted between a sending party computer 201, a sending bank computer 300, a bank PAN database 400, a payment processing network 105, and a recipient bank computer 203.

At step 701, sending party computer 201 sends transfer instructions comprising a recipient account number, “012345678” and a recipient bank routing number to sending bank computer 300. In some embodiments, the account number may be the recipient's checking account number, and the bank routing number may be the recipient bank's ABA routing number.

At step 702, sending bank computer 300 sends the recipient bank's routing number to a bank PAN database 400 to determine a bank PAN for the recipient bank. At step 703, the bank PAN database 400 returns a bank PAN, “4123-4500-0000-0008.” According to various embodiments, payment processing network 105 may not be able to recognize or use the recipient account number and/or the recipient bank routing number directly to process the funds transfer. Thus, a bank PAN that is compatible with payment processing network 105 is used.

At step 704, sending bank computer 300 generates an authorization request message comprising the recipient bank PAN, the recipient account number, and the recipient bank routing number. The authorization request message is sent to payment processing network 105.

At step 705, payment processing network 105 forwards the authorization request message to the appropriate recipient bank computer 203. The authorization request message may be forwarded by examining the recipient bank PAN. For example, the IIN for the recipient bank PAN may be “412345,” which may be associated with the specific recipient bank computer 203.

At step 706, recipient bank computer parses the authorization request message to credit the recipient account and sends an authorization response message to payment processing network 105. The shown authorization response message comprises an action code and an approval code.

The “action code” may include an identifier indicating the results of the authorization request. For example, the shown action code “00” may indicate that the transaction is approved and has completed successfully. Alternately, the action code “55” may indicate that an entered PIN was incorrect or missing. Various other action codes may be used in accordance with embodiments of the invention.

The “approval code” may include an authorization code from the recipient bank computer 203 or an issuer computer 106 associated with the recipient bank computer 203. For example, the approval code may be a six character string (e.g., “20304B”) used to identify the transaction or indicate that the recipient bank has approved the transaction.

At step 707, payment processing network 105 forwards the authorization response message to sending bank computer 300. Subsequently, sending bank computer 300 may notify sending party computer 201 that the transaction was successful.

III. Exemplary Authorization Message Structures

FIG. 8 shows an example of an original credit transaction (OCT) authorization request message for a transaction in one embodiment of the invention. The shown OCT authorization request message is represented using XML.

The OCT authorization request message includes a plurality of fields. For example, the OCT authorization request message includes audit and reference numbers such as “SystemsTraceAuditNumber” and “RetrievalReferenceNumber”.

The OCT authorization request message also includes the date and time of the transaction in the “DateAndTimeLocalTransaction” field.

The OCT authorization request message also includes information relating to the acquirer associated with the sending bank computer. For example, the “AcquiringBin” field may include the bank identification number (BIN) or IIN of the acquirer. The “AcquirerCountryCode” field may include the country of the acquirer.

The OCT authorization request message also includes information relating to the sending party. For example, the “SenderReference” field may include a reference number determined by the sending party. For example, if the transaction is a funds disbursement tranasction, or if the transaction was funded using cash, the sender reference may include an identifier generated to track the transaction. The “SenderAccountNumber” field may include an account number of a financial account used to fund the transaction, such as if the transaction is a money transfer, prepaid load, or credit card bill pay. The authorization request message may also include other fields relating to the currency, identity, and location of the sender, such as “SenderCountryCode,” “TransactionCurrency,” “SenderName,” “SenderAddress,” “SenderCity,” and “Sender StateCode.”

The OCT authorization request message may also include information regarding a recipient account. In cases where a recipient account corresponds to a PAN, “RecipientCardPrimaryAccountNumber” may include the recipient PAN. In cases where a recipient bank PAN (e.g., if the recipient account does not have a corresponding PAN) is used, “RecipientCardPrimaryAccountNumber” may include the recipient bank PAN. In cases where a recipient bank PAN is used, the “RecipientAccountIdentifier” field may include a recipient account identifier, and “RecipientBankIdentifier” field may include a recipient bank identifier.

The OCT authorization request message may also include an amount of funds to be transferred in “Amount” field.

The OCT authorization request message may also include information relating to a sending party computer 201 or other entity that conducts the transaction on behalf of a sending party. For example, “BusnessApplicationID” field and “MerchantCategoryCode” field may describe a merchant or service conducting the transaction, and the “CardAcceptor” field may include additional information such as a name and address of the merchant or service.

The OCT authorization request message may also include a transaction identifier, such as in the “Transaction Identifier” field, and a source of funds, such as in the “SourceOfFunds” field.

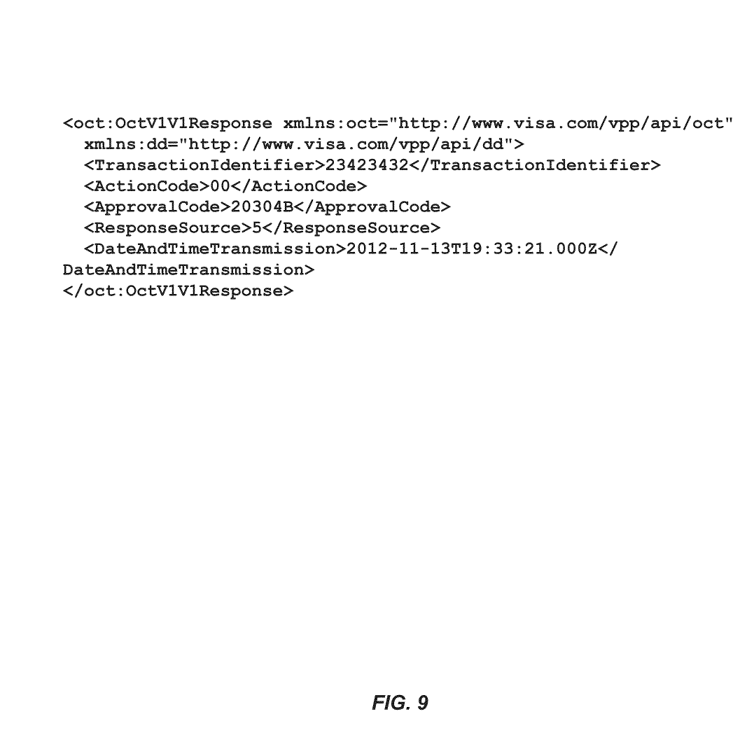

FIG. 9 shows an example of an OCT authorization response message according to one embodiment of the invention. The shown OCT authorization response message is represented using XML. However, any suitable format may be used.

The OCT authorization response message may include a transaction identifier, such as in the “Transaction Identifier” field. The transaction identifier may be the same as was included in the OCT authorization request message.

The OCT authorization response message may also include an “ActionCode” field and an “ApprovalCode” field. The “ActionCode” field may include an identifier indicating the results of the authorization request. For example, the shown action code “00” may indicate that the transaction is approved and has completed successfully. Alternately, the action code “55” may indicate that an entered PIN was incorrect or missing. Various other action codes may be used in accordance with embodiments of the invention. The “ApprovalCode” field may include an authorization code from the recipient bank computer 203 or an issuer computer 106 associated with the recipient bank computer 203. For example, the approval code may be a six character string (e.g., “20304B”) used to identify the transaction or indicate that the recipient bank has approved the transaction.

The OCT authorization response message may also include a “ResponseSource” field indicating whether an issuer computer 106, recipient bank computer 203, or another entity generated the OCT authorization response message. The OCT authorization response message may also include a “DateAndTimeTransmission” field including the date and time that the authorization response was transmitted.

IV. Exemplary Computer Apparatuses

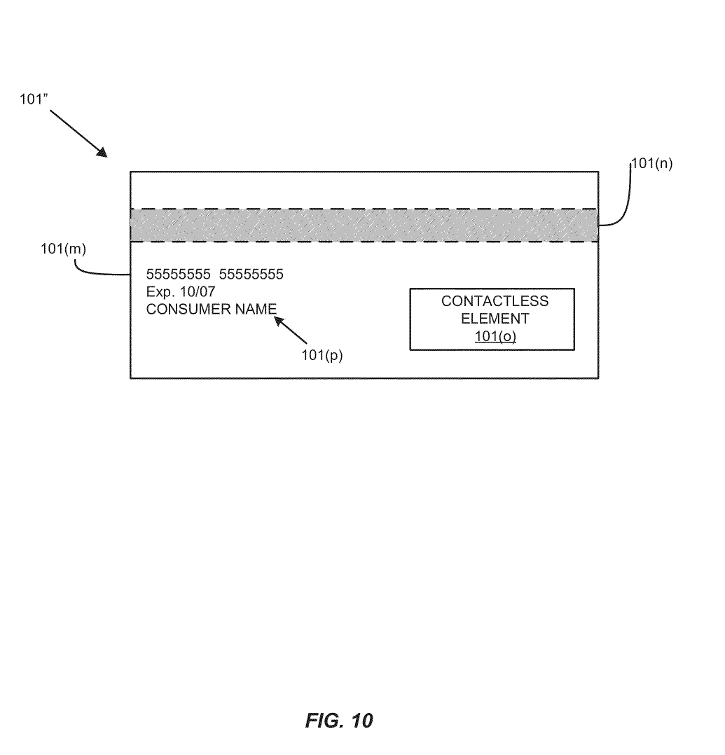

FIG. 10 shows an example of a payment device 101″ in the form of a card. As shown, the payment device 101″ comprises a plastic substrate 101(m). In some embodiments, a contactless element 101(o) for interfacing with an access device 102 may be present on, or embedded within, the plastic substrate 101(m). Consumer information 101(p) such as an account number, expiration date, and/or a user name may be printed or embossed on the card. A magnetic stripe 101(n) may also be on the plastic substrate 101(m). In some embodiments, the payment device 101″ may comprise a microprocessor and/or memory chips with user data stored in them.

As noted above and shown in FIG. 10, the payment device 101″ may include both a magnetic stripe 101(n) and a contactless element 101(o). In some embodiments, both the magnetic stripe 101(n) and the contactless element 101(o) may be in the payment device 101″. In some embodiments, either the magnetic stripe 101(n) or the contactless element 101(o) may be present in the payment device 101″.

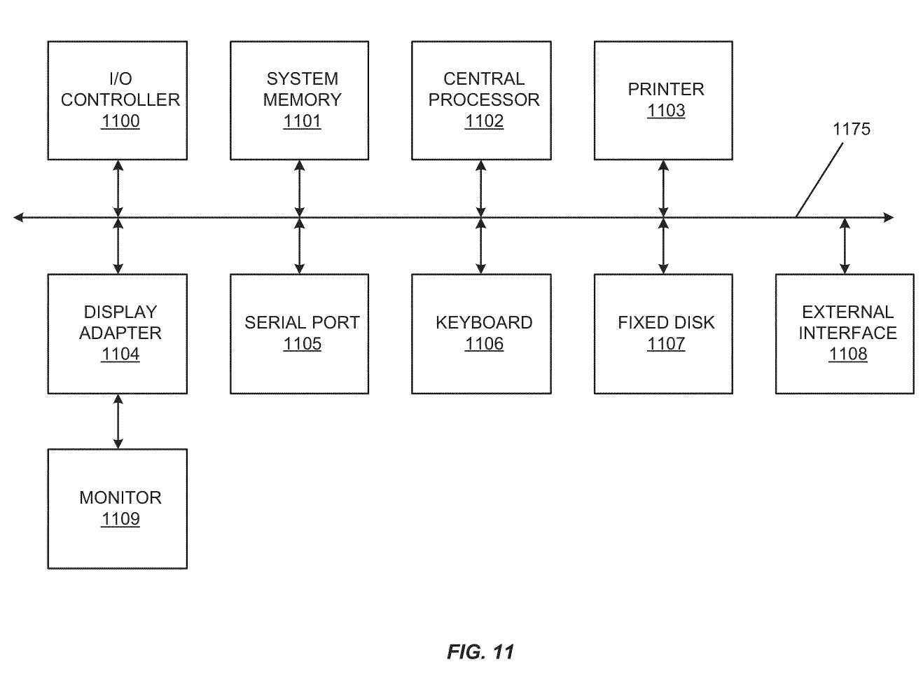

FIG. 11 is a high level block diagram of a computer system that may be used to implement any of the entities or components described above. The subsystems shown in FIG. 11 are interconnected via a system bus 1175. Additional subsystems include a printer 1103, keyboard 1106, fixed disk 1107, and monitor 1109, which is coupled to display adapter 1104. Peripherals and input/output (I/O) devices, which couple to I/O controller 1100, can be connected to the computer system by any number of means known in the art, such as a serial port. For example, serial port 1105 or external interface 1108 can be used to connect the computer apparatus to a wide area network such as the Internet, a mouse input device, or a scanner. The interconnection via system bus 1175 allows the central processor 1102 to communicate with each subsystem and to control the execution of instructions from system memory 1101 or the fixed disk 1107, as well as the exchange of information between subsystems. The system memory 1101 and/or the fixed disk may embody a computer-readable medium.

As described, the inventive service may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a”, “an” or “the” is intended to mean “at least one”, unless specifically indicated to the contrary.

1. A server computer, comprising:
a processor; and
a non-transitory computer-readable storage medium, comprising code executable by the processor for implementing a method comprising:
receiving a recipient bank identifier and a recipient account identifier associated with a recipient account;
determining a recipient bank primary account number (PAN) using the recipient bank identifier;
generating an authorization request message comprising the recipient bank PAN and the recipient account identifier;
sending an authorization request message for a transaction to a recipient bank computer, wherein the recipient bank PAN is used to route the authorization request message to the recipient bank computer; and
receiving an authorization response message.

2. The server computer of claim 1, wherein the bank PAN comprises an issuer identification number (IIN) associated with the recipient bank and an individual account identifier (IAI), wherein the IIN identifies the recipient bank, and wherein the IAI is constant for a plurality of recipient accounts associated with the recipient bank.

3. The server computer claim 2, wherein the bank PAN is 16 digits, and wherein the IIN is 6 digits.

4. The server computer of claim 1, wherein the transaction is a funds transfer from a sender account, and wherein the authorization request message comprises an amount of funds to be transferred from the sender account to the recipient account.

5. The server computer of claim 1, wherein the authorization request message further comprises the recipient bank identifier, wherein the recipient bank identifier and the recipient account identifier identify the recipient account.

6. The server computer of claim 1, wherein the recipient bank PAN is determined using a bank PAN database.

7. A computer-implemented method comprising:
receiving, by a processor, a recipient bank identifier and a recipient account identifier associated with a recipient account;
determining, by the processor, a recipient bank primary account number (PAN) using the recipient bank identifier;
generating, by the processor, an authorization request message comprising the recipient bank PAN and the recipient account identifier;
sending, by the processor, an authorization request message for a transaction to a recipient bank computer, wherein the recipient bank PAN is used to route the authorization request message to the recipient bank computer; and
receiving, by the processor, an authorization response message.

8. The computer-implemented method of claim 7, wherein the bank PAN comprises an issuer identification number (IIN) associated with the recipient bank and an individual account identifier (IAI), wherein the IIN identifies the recipient bank, and wherein the IAI is constant for a plurality of recipient accounts associated with the recipient bank.

9. The computer-implemented method of claim 8, wherein the bank PAN is 16 digits, and wherein the IIN is 6 digits.

10. The computer-implemented method of claim 7, wherein the transaction is a funds transfer from a sender account, and wherein the authorization request message comprises an amount of funds to be transferred from the sender account to the recipient account.

11. The computer-implemented method of claim 7, wherein the authorization request message further comprises the recipient bank identifier, wherein the recipient bank identifier and the recipient account identifier identify the recipient account.

12. The computer-implemented method of claim 7, wherein the recipient bank PAN is determined using a bank PAN database.

13. A server computer comprising:
a processor; and
a non-transitory computer-readable storage medium, comprising code executable by the processor for implementing a method comprising:
receiving an authorization request message for a transaction, the authorization request message comprising a recipient account identifier;
determining that the authorization request message includes a bank primary account number (PAN);
determining a recipient account using the recipient account identifier; and
sending an authorization response message to a sending bank computer.

14. The server computer of claim 13, wherein the bank PAN comprises an issuer identification number (IIN) associated with the recipient bank and an individual account identifier (IAI), wherein the IIN identifies the recipient bank, and wherein the IAI is constant for a plurality of recipient accounts associated with the recipient bank.

15. The server computer of claim 14, wherein the bank PAN is 16 digits, and wherein the IIN is 6 digits.

16. The server computer of claim 13, wherein the authorization request message further comprises the recipient bank identifier, wherein the recipient bank identifier and the recipient account identifier are used to determine the recipient account.

17. The server computer of claim 13, wherein the transaction is a funds transfer from a sender account, and wherein the authorization request message comprises an amount of funds to be transferred from the sender account to the recipient account.

18-25. (canceled)
